(19) United States
(12) Patent Application Publication
(10) Pub. No.: US 2026/0255148 A1
(43) Pub. Date: Aug. 27, 2026

(54) AP TO AP COMMUNICATION PROCEDURES FOR SEAMLESS ROAMING

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/466,216

(22) Filed: Jan. 30, 2026

Related U.S. Application Data
(60) Provisional application No. 63/762,931, filed on Feb. 25, 2025.
(60) Provisional application No. 63/922,555, filed on Nov. 21, 2025.

(51) Int. Cl. H04W 8/14; H04W 76/15

(52) U.S. Cl. CPC H04W 8/14; H04W 76/15

(57) ABSTRACT

Methods and apparatuses for link level feature handling procedures for seamless roaming. A method performed by a current access point (AP) multi-link device (MLD) comprises performing a roaming procedure associated with a non-AP MLD roaming from the current AP MLD to a target AP MLD. The method includes transmitting, to the non-AP MLD via an information element, information indicating that downlink data forwarding of buffered downlink data of the non-AP MLD is supported by the current AP MLD and the target AP MLD. The method further includes transmitting, to the target AP MLD, the buffered downlink data of the non-AP MLD during data forwarding.

### CROSS-REFERENCE TO RELATED APPLICATION(S) AND CLAIM OF PRIORITY

This application claims priority under 35 U.S.C. § 119 (e) to U.S. Provisional Patent Application No. 63/762,931, filed on Feb. 25, 2025, and U.S. Provisional Patent Application No. 63/922,555, filed on Nov. 21, 2025, each of which are hereby incorporated by reference in their entirety.

### TECHNICAL FIELD

This disclosure relates generally to wireless communication, and more specifically to access point (AP) to AP communication procedures for seamless roaming.

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for AP to AP communication procedures for seamless roaming.

In one embodiment, a method performed by a current access point (AP) multi-link device (MLD) comprises performing a roaming procedure associated with a non-AP MLD roaming from the current AP MLD to a target AP MLD. The method includes transmitting, to the non-AP MLD via an information element, information indicating that downlink data forwarding of buffered downlink data of the non-AP MLD is supported by the current AP MLD and the target AP MLD. The method further includes transmitting, to the target AP MLD, the buffered downlink data of the non-AP MLD during data forwarding.

In another embodiment, an electronic device comprises at least one processor including processing circuitry, and memory storing instructions. The instructions, when executed by the at least one processor individually or collectively, cause the electronic device to: perform a roaming procedure associated with a non-AP MLD roaming from a current AP MLD to a target AP MLD; transmit, to the non-AP MLD via an information element, information indicating that downlink data forwarding of buffered downlink data of the non-AP MLD is supported by the current AP MLD and the target AP MLD; and transmit, to the target AP MLD, the buffered downlink data of the non-AP MLD during data forwarding.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example interaction call flow between two domain communication agents (DCAs) according to embodiments of the present disclosure;

FIG. 4 illustrates an example call flow of association context exchange between a current AP MLD and a target AP MLD according to embodiments of the present disclosure;

FIG. 5 illustrates an example call flow of an enhanced discovery phase according to embodiments of the present disclosure;

FIG. 6 illustrates an example call flow of a recommendation phase according to embodiments of the present disclosure;

FIG. 7 illustrates an example call flow of a data forwarding phase according to embodiments of the present disclosure; and

FIG. 8 illustrates an example method performed by an access point (AP) multi-link device (MLD) in a wireless communication system according to embodiments of the present disclosure.

### DETAILED DESCRIPTION

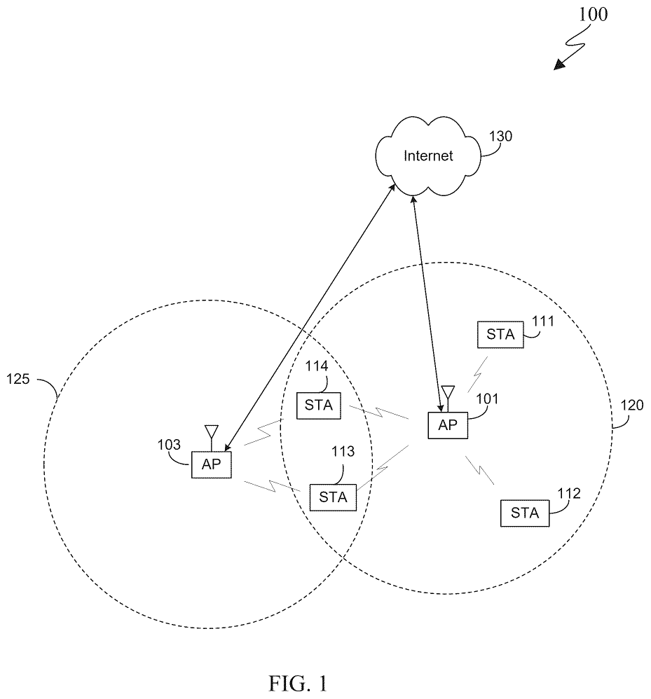

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11bn/D0.1, 2025.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating AP to AP communication procedures for seamless roaming in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

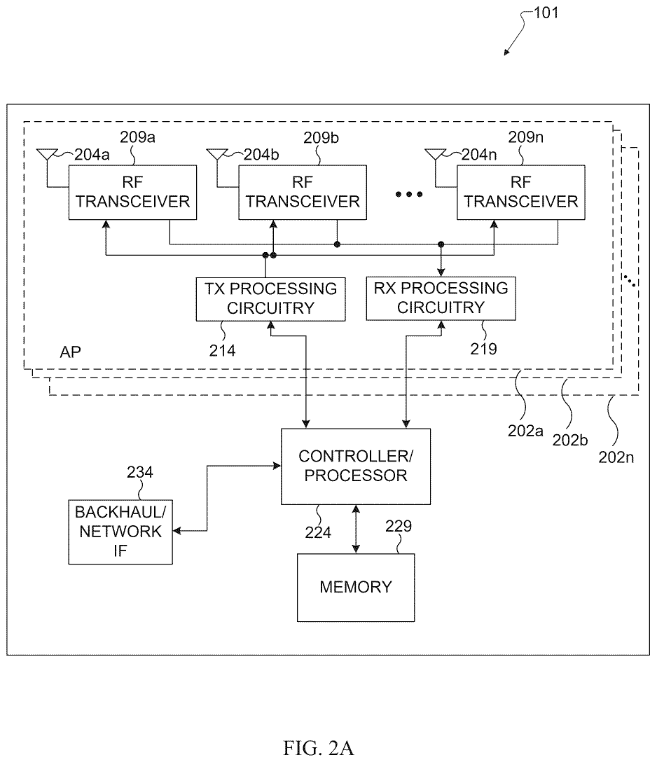

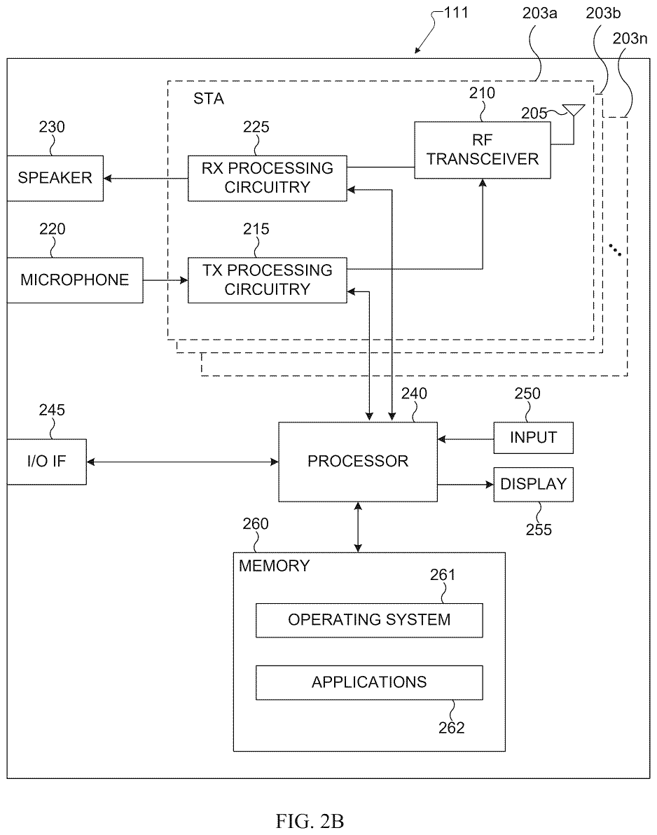

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHZ, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including DL data handling in seamless roaming in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating AP to AP communication procedures for seamless roaming in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHZ, 5 GHZ, or 6 GHZ, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. In some embodiments, the processor 240 includes at least one microprocessor or microcontroller.

The processor 240 is also capable of executing processes and programs resident in the memory 260, such as operations for participating in seamless roaming in WLANs. The processor 240 can move data into or out of the memory 260 as required by an executing process. In some embodiments, the processor 240 is configured to execute a plurality of applications 262, such as applications for participating in seamless roaming in WLANs. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

The goal of seamless roaming is to provide mechanisms for a non-AP MLD to transition from the current AP MLD to the target AP MLD such that the time during which the connection is lost is minimal. The seamless roaming procedure can enable a non-AP MLD to remain in state 4 while transitioning from the current AP MLD to the target AP MLD.

The roaming procedure can comprise multiple stages. Two of the stages are a preparation stage and a roam execution/transition stage. During the preparation stage, the non-AP MLD can setup links with the target AP MLD and perform context transfer. Following this stage, the non-AP MLD can perform a roam execution/transition procedure by sending a request frame to transition from the current AP MLD to the target AP MLD. The current AP MLD can process the request frame and send a response frame to the non-AP MLD after the transfer of context is complete.

These procedures can enable the non-AP MLD to seamlessly roam from the current AP MLD to the target AP MLD.

Embodiments of the present disclosure recognize scenarios that where a non-AP MLD that has one or more non-AP STAs affiliated with it, the non-AP MLD is capable of associating with an AP MLD with one or more affiliated AP STAs and setup one or more links with the AP MLD. The AP MLD can be a part of a seamless mobility domain (SMD). The SMD can include multiple AP MLDs where the non-AP MLD can perform an SMD BSS transition procedure between the AP MLDs while maintaining association with the seamless mobility domain management entity (SMD-ME). The SMD BSS transition can be a mechanism for a non-AP MLD to transition from its current AP MLD to a target AP MLD without requiring reassociation. Thus, the SMD BSS transition procedure can minimize the time during which the connectivity between the non-AP MLD and the distribution system (DS) is lost. The non-AP MLD can remain in state 4 of association with the SMD-ME during the SMD BSS transition while preserving the context for data transmission. This can result in a seamless experience. The SMD-ME can provide SMD-level authentication and association, IEEE 802.1X authenticator functions and the Robust Security Network Association (RSNA) key management function for non-AP MLDs across all AP MLDs within the SMD. The SMD can have two data path models between the non-AP MLD and the DS. One data path model can be one where a single MAC SAP is used for the SMD. Another data path model can be one which has a separate MAC SAP per AP MLD of the SMD. At a time, only one of the two data paths can be used.

The non-AP MLD can perform an initial association with the SMD-ME through an AP MLD within the SMD. This association can establish an SMD-level security association across all AP MLDs in the SMD. The non-AP MLD can transition between AP MLDs within this SMD while maintaining its association and security association with the SMD-ME.

The non-AP MLD can use mechanisms such as active scanning (e.g., probing, multi-link probe request and response exchanges, etc.), the BSS transition management (BTM) framework, the neighbor report framework for discovery of the neighboring AP MLDs and the SMD BSS transition support by those AP MLDs.

Further an AP MLD can use the BTM framework to recommend one or more candidate target AP MLDs within the SMD. The current AP MLD can transmit an unsolicited BTM request containing the candidate target AP's information. The non-AP MLD can also request for information on one or more candidate target AP MLDs in the SMD. The non-AP MLD can transmit a BTM query frame to the current AP MLD and request for candidate target AP MLD's information. Thus, the non-AP MLD can discover the capabilities, feature support and constraints at the target AP MLD.

When the non-AP MLD uses SMD BSS transition to transition from an AP MLD (referred to as the current AP MLD without loss of generality) to another AP MLD within the same SMD (referred to as the target AP MLD), the non-AP MLD can perform an SMD BSS transition preparation procedure. The preparation procedure can be performed in advance before the transition occurs. The preparation procedure can be performed by transmitting a preparation request frame to the current AP MLD. Each preparation request can identify a target AP MLD that the non-AP MLD intends to prepare for a transition. Based on the preparation request, there can be a transfer of context related to the non-AP MLD from the current AP MLD to the target AP MLD. Context can be resources or parameters associated with one or more features setup at the target AP MLD. Examples of contexts can be block acknowledgement (BA) setup parameters, SCS, MSCS, EPCS, etc. that are setup at the current AP MLD. Further, the preparation can also allow the non-AP MLD to add one or more links (i.e., form links with APs) with the target AP MLD. The current AP MLD can transmit a preparation response frame that can inform the non-AP MLD about the status of the preparation, the links added and the contexts out of the requested contexts that have been successfully transmitted. Some contexts can be assumed to be transferred even if not explicitly requested by the non-AP MLD.

The target AP MLD can be kept prepared for a certain period of time. Within this period of time, the non-AP MLD can be required to perform an execution procedure to the target AP MLD. If performed outside this period of time, the preparation can be considered as expired resulting in the context and added links getting deleted. In this case, the execution can fail. This period can be referred to as a timeout period in this disclosure.

The execution procedure can either be performed via the current AP MLD or via the target AP MLD. When the execution procedure is performed via the current AP MLD, the non-AP MLD can transmit an execution request frame to the current AP MLD. The current AP MLD can transfer any context that is required to be transferred (e.g., sequence number (SN)) and that is not already transferred to the target AP MLD. The current AP MLD can transfer an execution response frame to the non-AP MLD. When the execution procedure is performed via the target AP MLD, the non-AP MLD can transmit the execution request frame to the target AP MLD. The target AP MLD can then perform the transfer of any context that is required to be transferred and that is not already transferred from the current AP MLD to the target AP MLD. The target AP MLD can transmit an execution response frame to the non-AP MLD.

In WLANs, including next generation WLANs, during seamless roaming, there can be a need for AP to AP communication to facilitate information exchange between the two APs. For example, the current AP MLD of a non-AP MLD may need to exchange some roaming related information with a target AP MLD. A framework and procedure is needed for addressing this issue.

Accordingly, in this disclosure, a number of solutions are presented for handling AP to AP communication between two APs in an ultra-high reliability (UHR) seamless roaming domain, including:
1. Domain communication agent
2. Domain communication messages
3. Interaction between domain communication agents (DCAs) and domain communication messages (DCMs)
4. Example operation
5. Communication channel

### 1. Domain Communication Agent (DCA)

According to one embodiment, a remote communication agent can be used to facilitate communication between two APs in a UHR seamless roaming domain. The DCA can reside on each AP MLD in the domain. For example, in the SME on the AP MLDs. The DCA can perform forwarding and receiving functions for communication/information exchange between two AP MLDs in the domain.

### 1.a Sender Side DCA

When the DCA at the current AP MLD receives a request from the non-AP MLD that can be related to a target AP MLD in the same UHR seamless roaming domain, the DCA on the current AP MLD can forward the request to the DCA on the target AP MLD.

The DCA can also transmit messages that originate at the current AP MLD to the DCA at the target AP MLD. For example, the current AP MLD may want to request information from the target AP MLD.

### 1.b Receiver Side DCA

When the DCA at the target AP MLD receives a request from the DCA at the current AP MLD, the DCA can interact with the MAC and other parts of the SME to process the request and generate a response to the DCA on the current AP MLD.

### 2. Domain Communication Messages

According to one embodiment, two or more DCAs can communicate with each other by exchanging a domain communication message (DCM). The domain communication message can contain at least one or more of the information items as indicated in Table 1. The DCM can be known by any other name and can be interpreted as one or more frame exchanges that occur between the current AP MLD and the target AP MLD or one AP MLD and another AP MLD in the SMD.

TABLE 1
Information items that can be present in the DCM

| Information item | Description |
|---|---|
| Packet category | One or more information items that can indicate the category of |
| | the packet. For example, packet type. |
| Packet length | One or more information items that can indicate the length of the |
| | packet. For example, a number indicating the length in octets of |
| | the packet. |
| Originating AP | One or more information items that can serve as an identifier for |
| identifier | the AP MLD from where the message can originate. For |
| | example, AP MLD MAC address. |
| Destination AP | One or more information items that can serve as an identifier for |
| identifier | the AP MLD to which the message can be intended for. For |
| | example, AP MLD MAC address. |
| Message intent | One or more information items that can indicate the intention of |
| | the message. For example, request message soliciting a |
| | response/information from the target AP MLD, message intended |
| | to inform something to the target AP MLD, etc. |
| Message reference | One or more information items that can serve as a reference for |
| | the DCM. For example, a DCM message carrying a request can |
| | carry a dialog token and the same dialog token can be present in |
| | a response DCM message from the target AP MLD. |
| 802.11 frame contents | One or more information items that can be a part of a 802.11 |
| | frame exchanged between the non-AP MLD and the current AP |
| | MLD. The content can be packaged into the DCM and |
| | transmitted to the target AP MLD. For example, one or more |
| | fields of the link reconfiguration request frame. |
| AP/network side | One or more information items that can be information generated |
| information | and/or stored at the AP/network side. For example, security keys, |
| | key confirmation with target AP MLD, key derivation(s), etc. |
| Target AP MLD related | One or more information items that can be related to the target |
| contents | AP MLD or the response of the target AP MLD. These |
| | information items can be inserted into various 802.11 frames |
| | exchanged between the current AP MLD and the non-AP MLD |
| | after the DCA at the current AP MLD receives them in a DCM |
| | from the DCA at the target AP MLD. |
| 802.11 MSDUs/MPDUs | One or more information items that can be the 802.11 |
| | MSDUs/MPDUs or one or more information items associated |
| | with 802.11 MSDUs/MPDUs. For example, sequence number |
| | (SN), packet number (PN), TID, etc. As a part of the SMD BSS |
| | transition, the current AP MLD can forward downlink (DL) data |
| | to the target AP MLD. Information such as SN, PN and TID can |
| | be carried/communicated for MSDU-A-MSDU for each Data |
| | frame that is within WinStarto and WinEndo that needs |
| | retransmission and that can be forwarded from the current AP |
| | MLD to the target AP MLD. |
| | According to this embodiment, when a support for a downlink |
| | (DL) data forwarding support is advertised for an SMD by an AP |
| | MLD that is a part of the SMD, then during data forwarding |
| | information such as SN, PN and TID can be communicated for |
| | MSDU/A-MSDU for each data frame that is within WinStarto |
| | and WinEndo that can need retransmission and can be forwarded |
| | from the current AP MLD to the target AP MLD. |
| | The DL data forwarding support can be advertised to a non-AP |
| | MLD by the current AP MLD via a one bit indication in an SMD |
| | information element. The bit can be set to 1 if forwarding of |
| | buffered DL data of a non-AP MLD from the current AP MLD to |
| | a target AP MLD can be supported by an SMD and to 0 |
| | otherwise. The SMD information element can be advertised to a |
| | non-AP MLD via management frame such as beacons, probe |
| | responses, (re)association responses, etc. by the current AP |
| | MLD. |
| | There can be a period of time after the ST execution process |
| | when the non-AP MLD can still receive DL buffered frames |
| | from its current AP MLD. When this period ends or is |
| | terminated, the non-AP MLD can still keep its reordering buffer |
| | as it transitions to the target AP MLD. |
| | There can be another form of downlink data forwarding in which |
| | the forwarding of buffered DL MSDUs of a non-AP MLD from |
| | the current AP MLD to a target AP MLD is supported by the |
| | SMD. The support can be advertised via a one bit indication in |
| | the SMD information element. The bit can be set to 1 to make the |
| | indication and to 0 to indicate otherwise. |
| | In this form, the non-AP MLD can discard remaining packets |
| | behind any incomplete MSDU forming a hole in the receive |
| | reordering buffer when the DL drain period is terminated. The |
| | current AP MLD can release MSDUs in order of the increasing |
| | sequence number until a MSDU which hasn't been successfully |
| | delivered and all retransmission attempts haven't been exhausted |
| | is encountered. In other words, the current AP MLD cannot |
| | release MSDUs behind a MSDU which hasn't been successfully |
| | delivered and all retransmission attempts haven't been exhausted |
| | even these subsequent MSDUs or corresponding A-MSDUs have |
| | been successfully delivered. Such MSDUs can be forwarded to |
| | the target AP MLD. |

### 3. Interaction Between DCAs Using DCMs

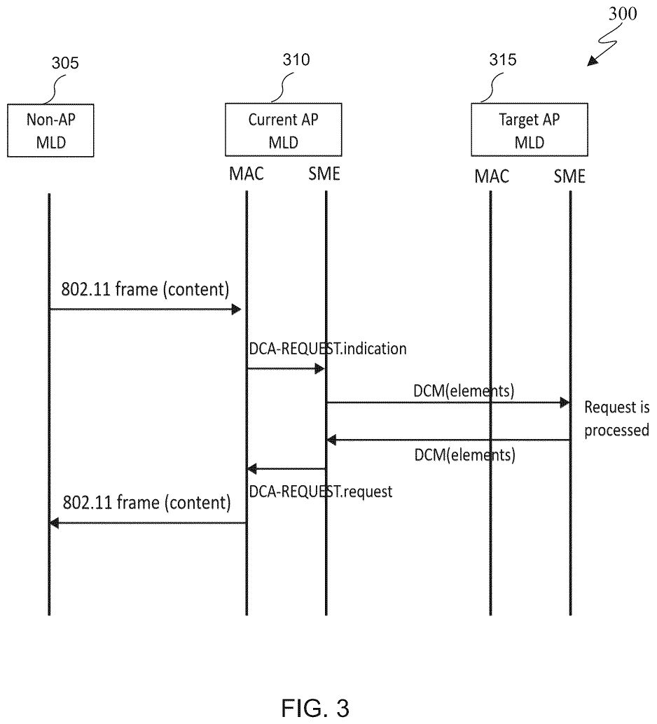

FIG. 3 illustrates an example interaction call flow 300 between two DCAs according to embodiments of the present disclosure. The example interaction call flow 300 between two DCAs shown in FIG. 3 is for illustration only. Other embodiments of an example interaction call flow between two DCAs could be used without departing from the scope of this disclosure.

According to one embodiment, the DCAs can interact with each other by exchanging DCMs as shown in FIG. 3. For example, when the DCA at the current AP MLD 310 receives a request from the non-AP MLD 305 that can be related to a target AP MLD 315 in the same UHR seamless roaming domain, the DCA on the current AP MLD 310 can forward the request to the DCA on the target AP MLD 315.

The DCA can also transmit messages that originate at the current AP MLD 310 to the DCA at the target AP MLD 315. For example, the current AP MLD may want to request information from the target AP MLD.

As another example, when the DCA at the target AP MLD 315 receives a request from the DCA at the current AP MLD 310, the DCA can interact with the MAC and other parts of the SME to process the request and generate a response to the DCA on the current AP MLD 310.

### 4. Example Operation

### 4.1 Association Context Exchange

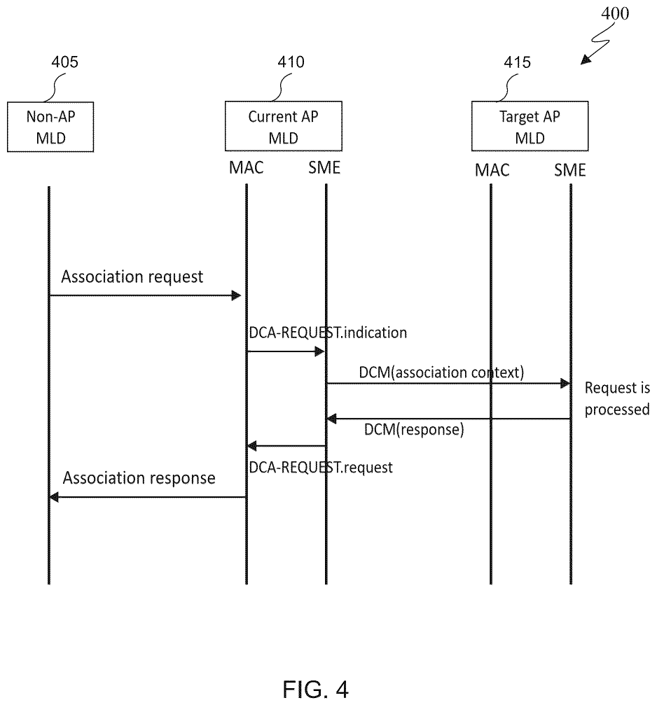

FIG. 4 illustrates an example call flow 400 of association context exchange between a current AP MLD and a target AP MLD according to embodiments of the present disclosure. The example call flow 400 of association context exchange between the current AP MLD and the target AP MLD shown in FIG. 4 is for illustration only. Other embodiments of an example call flow of association context exchange between the current AP MLD and the target AP MLD could be used without departing from the scope of this disclosure.

As shown in FIG. 4, in one example, a non-AP MLD can associate with an AP MLD. The AP MLD can share with another AP MLD, the association context of the non-AP MLD, for example, AID.

For example, when the DCA at the current AP MLD 410 receives an association request from the non-AP MLD 405, the DCA on the current AP MLD 410 can share the association context of the non-AP MLD with the target AP MLD 415 via the DCA on the target AP MLD 415.

### 4.2 Enhanced Discovery Phase

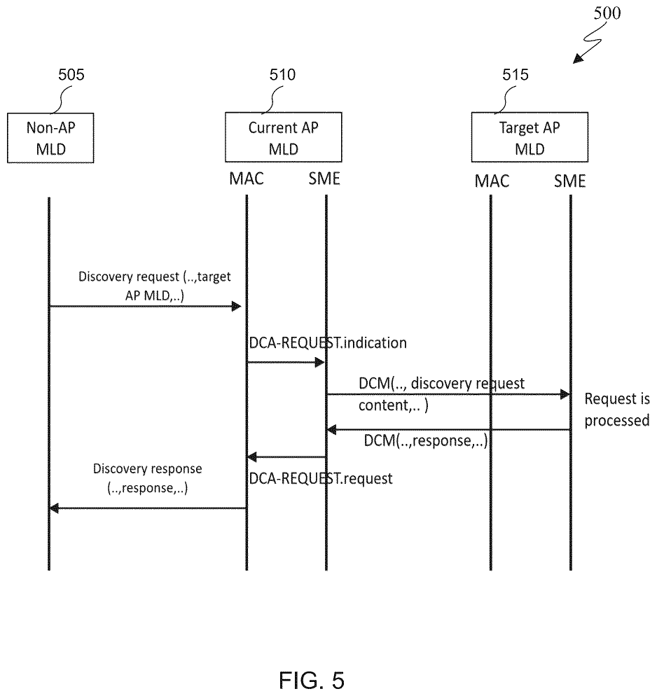

FIG. 5 illustrates an example call flow 500 of an enhanced discovery phase according to embodiments of the present disclosure. The example call flow 500 of an enhanced discovery phase shown in FIG. 5 is for illustration only. Other embodiments of an example call flow of an enhanced discovery phase could be used without departing from the scope of this disclosure.

As shown in FIG. 5, in another example, during an enhanced discovery phase, a non-AP MLD can request information about a target AP MLD in the UHR seamless roaming domain.

For example, when the DCA at the current AP MLD 510 receives a discovery request from the non-AP MLD 505, the DCA on the current AP MLD 510 can request information about the target AP MLD 515 via the DCA on the target AP MLD 515.

### 4.3 Recommendation Phase

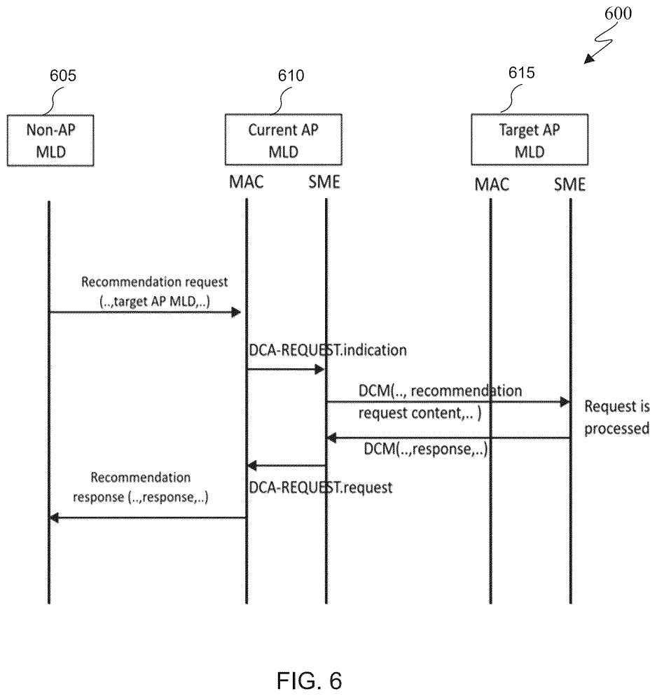

FIG. 6 illustrates an example call flow 600 of a recommendation phase according to embodiments of the present disclosure. The example call flow 600 of a recommendation phase shown in FIG. 6 is for illustration only. Other embodiments of an example call flow of a recommendation phase could be used without departing from the scope of this disclosure.

As shown in FIG. 6, in another example, during a recommendation phase, a non-AP MLD can request a recommendation about a target AP MLD in the UHR seamless roaming domain.

For example, when the DCA at the current AP MLD 610 receives a recommendation request from the non-AP MLD 605, the DCA on the current AP MLD 610 can request a recommendation about the target AP MLD 615 via the DCA on the target AP MLD 615.

### 4.4 Data Forwarding Phase Example

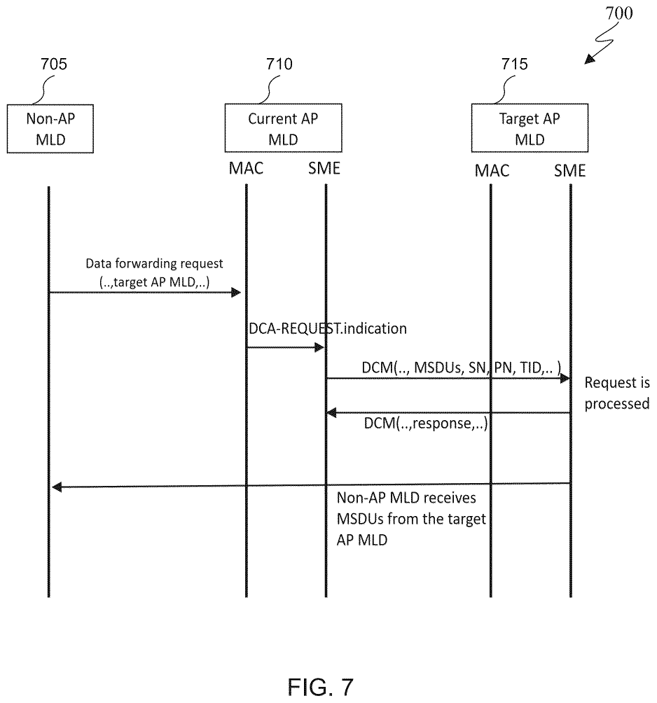

FIG. 7 illustrates an example call flow 700 of a data forwarding phase according to embodiments of the present disclosure. The example call flow 700 of a data forwarding phase shown in FIG. 7 is for illustration only. Other embodiments of an example call flow of a data forwarding phase could be used without departing from the scope of this disclosure.

As shown in FIG. 7, in one example, a data forwarding support can be advertised to the non-AP MLD 705 ahead of time by one or more means discussed previously (see examples in Table 1). The non-AP MLD 705 can transmit a data forwarding request message. This message can be an explicit data forwarding request message or an implicit data forwarding request message. Thus, a non-AP MLD can transmit an ST preparation request frame or an ST execution request frame or a UHR link reconfiguration notify frame (such as the one indicating a termination of DL draining period) and this can be viewed as a downlink data forwarding request message. Upon receiving such a message, the current AP MLD 710 can forward the non-AP MLD's buffered frames and corresponding information (such as the one discussed previously) to the target AP MLD 715.

According to another embodiment, there may not be an explicit request and the request can be implicit. For instance, completion of an ST execution phase or DL draining period can be viewed as the event that triggers a forwarding of the non-AP MLD's 705 buffered frames and corresponding information (such as the one discussed previously) from the current AP MLD 710 to the target AP MLD 715.

### 5. Communication Channel

The SMD-ME and the AP MLDs that are managed by the SMD-ME can have a secure channel between them that can be used to exchange cryptographic keys without exposure to any intermediate parties. The cryptographic strength of the secure channel between the SMD-ME and the AP MLDs can be greater than or equal to the cryptographic strength of the channels for which the keys are used.

An SMD that has such a secure communication channel can advertise its capability to the non-AP MLD. The current AP MLD can transmit a frame (e.g., a management frame) with an SMD information element (or another element) that indicates to the non-AP MLD about the presence of such a secure channel.

Based on the knowledge of the existence of the secure channel via the frame received from the current AP MLD, the non-AP MLD can then make data forwarding request (if data forwarding is supported as well) to the current AP MLD.

The seamless roaming domain can also be called by other names such as seamless mobility domain (SMD), non-collocated AP MLD, etc.

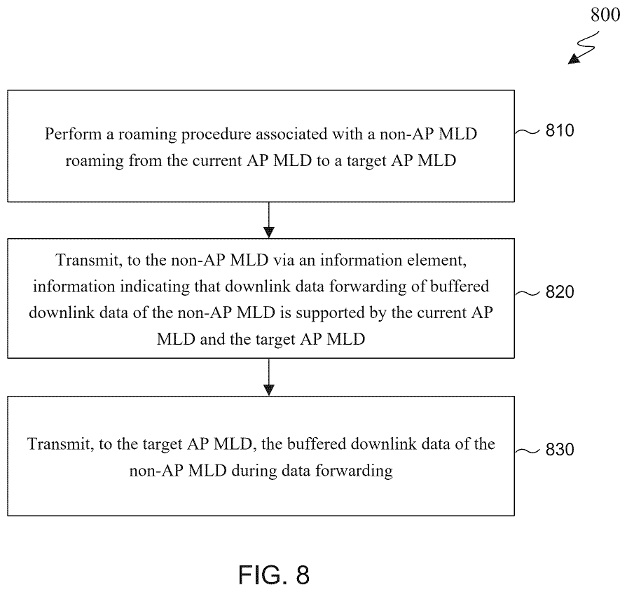

FIG. 8 illustrates an example method 800 performed by a current access point (AP) multi-link device (MLD) in a wireless communication system according to embodiments of the present disclosure. The method 800 of FIG. 8 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 800 is for illustration only and other embodiments can be used without departing from the scope of the present disclosure.

As illustrated in FIG. 8, the method 800 begins at step 810, where the current AP MLD performs a roaming procedure associated with a non-AP MLD roaming from the current AP MLD to a target AP MLD. At step 820, the current AP MLD transmits, to the non-AP MLD via an information element, information indicating that downlink data forwarding of buffered downlink data of the non-AP MLD is supported by the current AP MLD and the target AP MLD. At step 830. The current AP MLD transmits, to the target AP MLD, the buffered downlink data of the non-AP MLD during data forwarding.

In some embodiments, the current AP MLD transmits the information element via a management frame.

In some embodiments, during data forwarding, information corresponding to data frames in the buffered downlink data comprising at least one of a sequence number, a packet number, and a traffic identifier is communicated for an aggregate medium access control service data unit (MSDU/A)-MSDU for each data frame that is within a transmission window.

In some embodiments, the current AP MLD transmits, to the non-AP MLD, downlink buffered data frames for a duration of time after an execution process of the roaming procedure is complete.

In some embodiments, the duration of time comprises a downlink draining period which includes an amount of time needed to drain a downlink buffer of the current AP MLD, and the current AP MLD releases medium access control service data units (MSDUs) in order of increasing sequence number until an MSDU that has not been successfully delivered and all retransmission attempts have not been exhausted is encountered.

In some embodiments, the current AP MLD transmits, to the target AP MLD via a first domain communication agent at the current AP MLD, a request for information exchange with the target AP MLD; and receives, from the target AP MLD via a second domain communication agent at the target AP MLD, a response to the request for information exchange.

In some embodiments, the current AP MLD receives, from the non-AP MLD via a first domain communication agent at the current AP MLD, a request associated with the target AP MLD; and forwards, to the target AP MLD via the first domain communication agent, the request associated with the target AP MLD.

In some embodiments, the request for information exchange comprises a first domain communication message that includes a frame exchange that occurs between the current AP MLD and the target AP MLD, and the response to the request for information comprises a second domain communication message that includes a frame exchange that occurs between the current AP MLD and the target AP MLD.

In some embodiments, the first domain communication message comprises information indicating an association context of the non-AP MLD, and the second domain communication message comprises information associated with the association context of the non-AP MLD.

In some embodiments, the information element indicates to the non-AP MLD a presence of a secure communication channel between a seamless mobility domain management entity (SMD-ME) and AP MLDs that are managed by the SMD-ME, the current AP MLD and the non-AP MLD are managed by the SMD-ME, and the current AP MLD receives, from the non-AP MLD, a data forwarding request for forwarding the buffered downlink data of the non-AP MLD to the target AP MLD.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a current access point (AP) multi-link device (MLD), the method comprising:
performing a roaming procedure associated with a non-AP MLD roaming from the current AP MLD to a target AP MLD;
transmitting, to the non-AP MLD via an information element, information indicating that downlink data forwarding of buffered downlink data of the non-AP MLD is supported by the current AP MLD and the target AP MLD; and
transmitting, to the target AP MLD, the buffered downlink data of the non-AP MLD during data forwarding.

2. The method of claim 1, further comprising transmitting the information element via a management frame.

3. The method of claim 1, wherein during data forwarding, information corresponding to data frames in the buffered downlink data comprising at least one of a sequence number, a packet number, and a traffic identifier is communicated for an aggregate medium access control service data unit (MSDU/A)-MSDU for each data frame that is within a transmission window.

4. The method of claim 1, further comprising transmitting, to the non-AP MLD, downlink buffered data frames for a duration of time after an execution process of the roaming procedure is complete.

5. The method of claim 4, wherein:
the duration of time comprises a downlink draining period which includes an amount of time needed to drain a downlink buffer of the current AP MLD, and
the method further comprises releasing medium access control service data units (MSDUs) in order of increasing sequence number until an MSDU that has not been successfully delivered and all retransmission attempts have not been exhausted is encountered.

6. The method of claim 1, further comprising:
transmitting, to the target AP MLD via a first domain communication agent at the current AP MLD, a request for information exchange with the target AP MLD; and
receiving, from the target AP MLD via a second domain communication agent at the target AP MLD, a response to the request for information exchange.

7. The method of claim 1, further comprising:
receiving, from the non-AP MLD via a first domain communication agent at the current AP MLD, a request associated with the target AP MLD; and
forwarding, to the target AP MLD via the first domain communication agent, the request associated with the target AP MLD.

8. The method of claim 6, wherein:
the request for information exchange comprises a first domain communication message that includes a frame exchange that occurs between the current AP MLD and the target AP MLD, and
the response to the request for information comprises a second domain communication message that includes a frame exchange that occurs between the current AP MLD and the target AP MLD.

9. The method of claim 8, wherein:
the first domain communication message comprises information indicating an association context of the non-AP MLD, and
the second domain communication message comprises information associated with the association context of the non-AP MLD.

10. The method of claim 1, wherein:
the information element indicates to the non-AP MLD a presence of a secure communication channel between a seamless mobility domain management entity (SMD-ME) and AP MLDs that are managed by the SMD-ME,
the current AP MLD and the non-AP MLD are managed by the SMD-ME, and
the method further comprises receiving, from the non-AP MLD, a data forwarding request for forwarding the buffered downlink data of the non-AP MLD to the target AP MLD.

11. An electronic device comprising:
at least one processor including processing circuitry; and
memory storing instructions, wherein the instructions, when executed by the at least one processor individually or collectively, cause the electronic device to:
perform a roaming procedure associated with a non-access point (AP) multi-link device (MLD) roaming from a current AP MLD to a target AP MLD;
transmit, to the non-AP MLD via an information element, information indicating that downlink data forwarding of buffered downlink data of the non-AP MLD is supported by the current AP MLD and the target AP MLD; and
transmit, to the target AP MLD, the buffered downlink data of the non-AP MLD during data forwarding.

12. The electronic device of claim 11, wherein the instructions, when executed by the at least one processor individually or collectively, cause the electronic device to transmit the information element via a management frame.

13. The electronic device of claim 11, wherein during data forwarding, information corresponding to data frames in the buffered downlink data comprising at least one of a sequence number, a packet number, and a traffic identifier is communicated for an aggregate medium access control service data unit (MSDU/A)-MSDU for each data frame that is within a transmission window.

14. The electronic device of claim 11, wherein the instructions, when executed by the at least one processor individually or collectively, cause the electronic device to transmit, to the non-AP MLD, downlink buffered data frames for a duration of time after an execution process of the roaming procedure is complete.

15. The electronic device of claim 14, wherein:
the duration of time comprises a downlink draining period which includes an amount of time needed to drain a downlink buffer of the current AP MLD, and
the instructions, when executed by the at least one processor individually or collectively, cause the electronic device to release medium access control service data units (MSDUs) in order of increasing sequence number until an MSDU that has not been successfully delivered and all retransmission attempts have not been exhausted is encountered.

16. The electronic device of claim 11, wherein the instructions, when executed by the at least one processor individually or collectively, cause the electronic device to:
transmit, to the target AP MLD via a first domain communication agent at the current AP MLD, a request for information exchange with the target AP MLD; and
receive, from the target AP MLD via a second domain communication agent at the target AP MLD, a response to the request for information exchange.

17. The electronic device of claim 11, wherein the instructions, when executed by the at least one processor individually or collectively, cause the electronic device to:
receive, from the non-AP MLD via a first domain communication agent at the current AP MLD, a request associated with the target AP MLD; and
forward, to the target AP MLD via the first domain communication agent, the request associated with the target AP MLD.

18. The electronic device of claim 16, wherein:
the request for information exchange comprises a first domain communication message that includes a frame exchange that occurs between the current AP MLD and the target AP MLD, and
the response to the request for information comprises a second domain communication message that includes a frame exchange that occurs between the current AP MLD and the target AP MLD.

19. The electronic device of claim 18, wherein:
the first domain communication message comprises information indicating an association context of the non-AP MLD, and
the second domain communication message comprises information associated with the association context of the non-AP MLD.

20. The electronic device of claim 11, wherein:
the information element indicates to the non-AP MLD a presence of a secure communication channel between a seamless mobility domain management entity (SMD-ME) and AP MLDs that are managed by the SMD-ME,
the current AP MLD and the non-AP MLD are managed by the SMD-ME, and
the instructions, when executed by the at least one processor individually or collectively, cause the electronic device to receive, from the non-AP MLD, a data forwarding request for forwarding the buffered downlink data of the non-AP MLD to the target AP MLD.
